(19) United States
(12) Patent Application Publication
(10) Pub. No.: US 2008/0016178 A1
(43) Pub. Date: Jan. 17, 2008

(54) METHOD AND SYSTEM FOR REMOTE SOFTWARE INSTALLATION, RECOVERY, AND RESTORATION OVER A DATA NETWORK

(76) Inventor: Ellie Portugali, Zichron Yakov (IL)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/778,117

(22) Filed: Jul. 16, 2007

(30) Foreign Application Priority Data
Jul. 16, 2006 (IL) 176890

(51) Int. Cl. G06F 15/16; G06F 11/00

(52) U.S. Cl. 709/217; 714/43

(57) ABSTRACT

System and method for disaster recovery, remote installation and restoration of software and/or data over a data network, when a computer system includes a CPU, read/write internal memory means, an optional display, an optional input device, means for communicating with a data network, a bootable device input port and a hard disk, a bootable removable media means with a live operating system that is stored therein is coupled to the computer system A server that comprises a CPU and memory and software components for exchanging encrypted data, software packages, optional subscriber database with licensing information of each subscriber, and optional data files is adapted to communicate with a plurality of computer systems. The removable memory means performs a first boot operation, to scan hardware of the computer system and network connections, to establish networking connections, to establish a secured channel between the communicating means of the computer system and the server, over the networking connection, either within one data network, or over multiple data networks, and to transmit an optionally unique hardware signature over the secured channel to the server, for checking if the configuration that corresponds to the signature exists, and for executing a default process or otherwise, proposing relevant recovery options to the user of the computer system and for preparing appropriate files and software packages for the selected recovery option.

### CROSS-REFERENCE TO RELATED APPLICATION

This application claims priority under 35 U.S.C. §119 to Israeli Patent Application No. 176890 filed Jul. 16, 2006, the entire contents of which are incorporated herein by reference.

### FIELD OF THE INVENTION

The present invention relates to the field of computing devices. More particularly, the invention relates to a method and system for remotely restoring data and software applications of a computing device, such as a personal computer, that has suffered from software and/or data corruption, and for remotely performing advanced and privileged operations on a target computer, including, but not limited to, operations such as partitioning, installation of operating system software, and deletion or replacement of files.

### BACKGROUND OF THE INVENTION

A computer system that is in communication with the Internet is exposed to software commonly referred to as malicious software, e.g. a virus. Malicious software, or malware, is programmed by malevolent people in order to infect the computer system in such a way that a catastrophic loss of valuable computer data or of access to the data occurs as a result of a predetermined trigger event, for example the execution of a given program. Some viruses overwrite key files on a local computer hard disk drive or corrupt a software application or even the operating system (OS), requiring professional assistance in order to recover the corrupted data or files, if at all possible. The so-called disaster recovery is a time-consuming and expensive process in which the hard disk needs to be reformatted and reinstalled, the same applies to hardware failures, such as a hard disk failure/malfunction, where after replacement of said hardware, the operating system, software, data files, and setting need to be reinstated.

U.S. Pat. No. 6,411,943 discloses an online service system accessible by remote users which provides for example antiviral protection. This system is operable only when the operating system of a user computer device is functional and a network connection exists with a backup server, which has previously performed backup of key software files from the user computer device. However, this system is incapable of providing disaster recovery when the operating system of the user computer device is not functional or corrupted, or if the network stack is not operational. Furthermore, this system requires a working OS on the customer side, as well as a working network connection to the backup server. The existing software packages are needed to be backed up first—only then, the system can restore some or all backed up existing software packages.

U.S. Pat. No. 6,757,837 discloses a method and system for software failure diagnosis and repair. The system detects a software failure and allows the client to dial up to a repair server designed for supplying repair software. Once connection to the server is established, the repair server is able to identify and repair the software failures found in the client device without having to change the software. As indicated by the applicant, the cost of reformatting a file system over a modem line is prohibitive, and furthermore, the repair server is not able to repair all possible software failures or to reinstall the system.

U.S. Pat. No. 6,829,732 discloses a method for receiving recovery software from a network. The computing device transmits an identifier to a network location. The transmitted identifier is received by a network server, which determines the software package previously installed on the computing device during the manufacturing of the device. In this method, the recovery software is based on a software package installed during the manufacturing of the computing device, and cannot be assembled as a generic solution when the configuration of original factory-installed software package is unknown. In addition, the identifier and software package are Built To Customer Order (BTCO) and stored for future recovery, and therefore must be installed before the computing device is transported to the customer. If the hard disk has been corrupted or replaced, for example, it cannot be booted and therefore cannot receive the recovered software package.

US 2002/0083362 discloses a system and method for providing unattended self-recovery to Internet-based end-user devices. The hard drive of the end-user device is partitioned wherein one partition contains the operating system and the other partition contains an image of the operating system. In the event of a failure, the image and the personal information enabling the device to communicate with and be monitored by the network operating center are copied to the second partition. The installed remote system can then be rebooted via the second partition. If a virus infects both partitions of the end-user device, or if the hardware malfunctions to such a degree that both the first and second partitions are inoperable, the remote system will not be able to be rebooted. In addition, storing the remote boot capability in a dedicated partition on the HD significantly reduced the available storage volume that can be used. Moreover, overtime, the content of the active OS partition changes and therefore, the image on the second partition does not restore the computing device to its last known working conditions, but to the factory defaults.

All of the above publications failed to provide a system and methodology that are capable of remotely formatting and reinstalling a commuting device over an encrypted and secured data channel, and in any network environment.

In addition, most of the above publications discuss communications over and via a single data network, without the ability to provide support for multiple data networks and the associated routing and firewall issues associated with such setups.

It is an object of the present invention to provide a remote disaster recovery system and method for a computer system that has been infected by malware and/or suffers from hardware failure or replacement to such a degree that its operating system is inoperable or not present or partly operative.

It is an additional object of the present invention to provide a remote disaster recovery system and method that are cost effective.

It is an additional object of the present invention to provide a remote disaster recovery system and method for new and previously un-encountered computing devices and hardware.

It is an additional object of the present invention to provide a remote disaster recovery system and method that can repair a corrupted computer system even when the configuration of the operating system is unknown.

It is yet an additional object of the present invention to provide a remote disaster recovery system and method by which the computer system can be installed with an updated or different operating system and software.

It is yet an additional object of the present invention to provide a remote and automatic operating system installation operation from scratch with which a layman may easily interface.

It is yet an additional object of the present invention to provide said services and more, in a variety of different network environments and heterogeneous setups, as well as a multiplicity of data networks, with connecting firewalls and routing schemes.

Other objects and advantages of the invention will become apparent as the description proceeds.

### SUMMARY OF THE INVENTION

The present invention is directed to a method for disaster recovery, remote installation and restoration of software and/or data over a data network. When a computer system includes one or more central processing units (CPU), read/write internal memory means, an optional display, an optional input device, means for communicating with a data network, a bootable device input port and a hard disk, a bootable removable media means with a live operating system that is stored therein is coupled to the computer system. A server that comprises a CPU and memory and software components for exchanging encrypted data, software packages, optional subscriber database with licensing information of each subscriber, and optional data files is adapted to communicate with a plurality of computer systems. The removable memory means performs a first boot operation, to scan hardware of the computer system and network connections, to establish networking connections, to establish a secured channel between the communicating means of the computer system and the server, over the networking connection, either within one data network, or over multiple data networks, and to transmit an optionally unique hardware signature over the secured channel to the server, for checking if the configuration that corresponds to the signature exists, and for executing a default process or otherwise, proposing relevant recovery options to the user of the computer system and for preparing appropriate files and software packages for the selected recovery option.

If required, the live OS downloads the required software components from the server. The live OS may execute the required software components locally, after downloading, or from a removable media. The secured channel may be a VPN or an SSH (Secure Shell Protocol) or a secured HTTP session, such as HTTPS (Hypertext Transfer Protocol over Secure Socket Layer). If partial VM (Virtual Machine) is needed, the live OS locally executes the Partial VM (PVM), which is virtualized at least over the CPU and memory and optionally over the network interface card of the computer system and/or any other bootable media. The VM performs boot operation over the secured channel, such that the files required for that boot are read from the server. The server prepares the files for the VM according to a default state, or to the selection of the user and the VM runs the required operation.

The bootable removable media means may include an optical drive or a Floppy drive or a USB port or any other type of a bootable media and may comprise a portable disk and associated drive in data communication with the internal memory means of the computer system. The display and input device of the computer system may be adapted to communicate user selected installation preferences in real-time.

The software package may be an image extracted from the original operating system of the computer system. The image represents an essentially identical setup and configuration as that of the original operating system. Recovery operations may include installing a new OS and software packages; reinstalling OS and software packages; recovery of deleted files and folders; scanning and fixing parts of a corrupted OS and software; extracting or replacing forgotten passwords; scanning and removing malware; and performing defragmentation and optimization of existing file system.

Files and software packages may be prepared for recovery by the server by combining generic OS installation files with matching and appropriate keys, serials and/or licenses; generating and combining additional software packages with their matching and appropriate keys, serials and/or licenses; generating one or more files containing information for unattended automatic uninterrupted installation; optionally, generating and combining user data, settings and preferences stored in a storage system; combining the generated installation files and additional files into a file system, for allowing a single continuous operation.

By using the term “data network” it is meant to include any data network and a plurality of data networks, connected together.

The present invention is also directed to a disaster recovery system for the remote installation recovery, and restoration of software and/or data over a data network, that comprises:

a computer system having at least one central processing unit (CPU), read/write internal memory means, an optional display, an optional input device, means for communicating with a data network, a bootable device input port and a hard disk;

bootable removable media means with a live operating system being stored therein; and

a server adapted to communicate with a plurality of computer systems, the server comprising:

a CPU and memory and software components for exchanging encrypted data with the computer system, installation packages, software packages, optional subscriber database with licensing information of each subscriber, and optional data files The removable media means is operative in a first boot operation to scan hardware of the computer system and network connections, to establish networking connections, to establish a secured channel between the communicating means of the computer system and the server, over the networking connection and to transmit the optionally unique hardware signature of the computer system, over the secured channel to the server, for checking if the configuration that corresponds to the hardware signature exists, and for executing a default process or otherwise, proposing relevant recovery options to the user of the computer system and for preparing appropriate files and software packages for the selected recovery option.

### BRIEF DESCRIPTION OF THE DRAWINGS

In the drawings:

FIG. 1 is a schematic drawing of a remote disaster recovery system, according to one embodiment of the invention, illustrating a first boot operation;

FIG. 2 is a flow diagram of a remote disaster recovery method, according to one embodiment of the invention;

FIG. 3 illustrates several possibilities of network topology, by which an operating system may be installed on a target computer according to one embodiment of the invention, and shows multiple, connected data networks with optional switches, firewalls and routers; and

FIG. 4 is a flowchart of a preferred embodiment of the present invention.

### DETAILED DESCRIPTION OF PREFERRED EMBODIMENTS

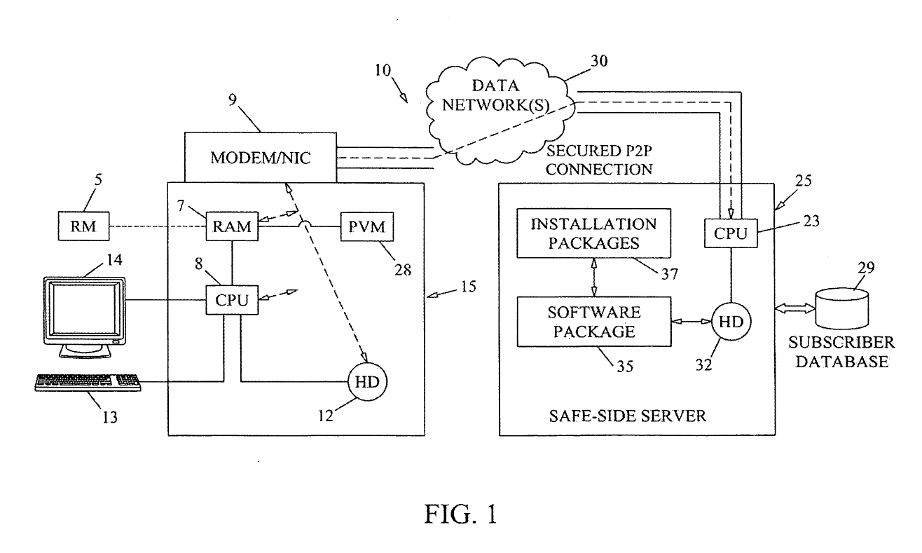

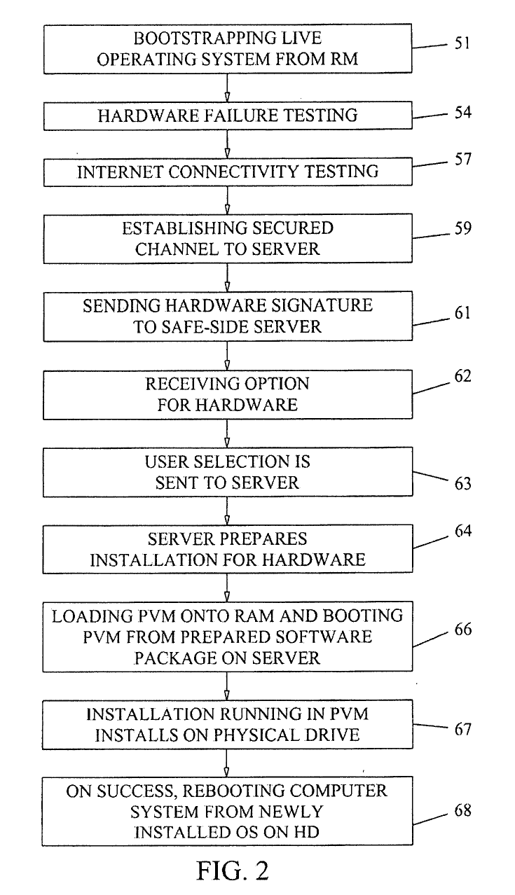

FIG. 1 illustrates the remote disaster recovery system, which is generally indicated by numeral 10, according to one embodiment of the present invention. Disaster recovery system 10 comprises a plurality of end-user computer systems 15, one of which being illustrated, safe-side server 25 which is capable of supporting multiple end-user computer systems such as 15 and provide IT services (e.g., recovery, restoration, installation etc.) via Internet 30 or any other suitable data network to each of the computer systems 15 when necessary, and Removable Media (RM) 5, such as a Compact Disk (CD) or a portable device (e.g., a Disk-On-Key), connected to computer system 15 (for example, via a USB bus), for each corresponding computer system 15, to initiate the installation process by performing two boot operations as will be described hereinafter, when information on corresponding Hard Disk (HD) 12 is corrupted and is inoperable, e.g., by malicious software or by hardware failure. The safe-side server 25 is used for new installations, reinstallations, backup services and restoration and image construction and storage.

While recovery software is transmitted by prior art methods via the Internet to a computer system only if the hard disk or and its operating system is operational, the method of the present invention bypasses hard disk 12 when the software of the latter is inoperable. RM 5 is provided with a software module hereinafter referred to as a “Live Operating System”, which is an operating system such as, KNOPPIX which is a bootable Live Operating System on CD, DVD or thumb-drive, consisting of a representative collection of software, automatic hardware detection, and support for many graphics cards, sound cards, SCSI (Small Computer System Interface) and USB devices and other peripheral devices. The live operating system, after being bootstrapped by RM 5 onto random access memory (RAM) 7, is able to interface with central processing unit (CPU) 8, to initiate a network topology detection operation to establish a network connection. Likewise, the live operating system is able to interface with input device 13 and monitor 14 of computer system 15 by means of CPU 8 so that a user may enter and receive data in a similar fashion as what was carried out in conjunction with the original operating system of computer system 15. The network connections are secured and encrypted segments 14 and 16 of a secured Point To Point connection, such as a Virtual Private Network (VPN) channel, which connects computer system 15 via Internet 30 with the safe-side server 25. Advanced and privileged operations can be performed using the method proposed by the present invention, since it operates external to the operating system that exists on the computer systems 15, and therefore, is not limited to the authorizations defined by the existing operating system.

After secured connection is established, safe-side server 25 receives a unique hardware signature identification (e.g., a UUID) request from the Live OS. The safe side server checks whether or not the computer system 15 is known as a subscriber, and provides a list of matching operations for said computer system 15. Then the end user of computer system 15 selects the desired operation, e.g., installation or reinstallation of an OS, software packages and data. If, for example, an installation operation is selected, then the Live OS runs PVM 28 which is virtualized over the CPU 8, memory and network connection and/or a bootable device. The partial VM is bootstrapped from a software package prepared by the safe side server 25. Safe side server 25 prepares the software packages required by combining generic installation packages 37 with the subscriber's licenses, configuration and settings, or computes the settings for computer system 15 (e.g., time zone definitions), that are stored in a subscriber's database 29, that can reside on the safe side server 25 or in another accessible location.

FIG. 1 also illustrates the boot operation that is performed by the PVM. While the VPN channel continues to be established between RM 5 and safe-side server 25, this boot operation is adapted to install the features of a desired operating system, whether an operating system substantially identical to the original operating system, or if desired, different from the original operating system, onto hard disk 12 of computer system 15.

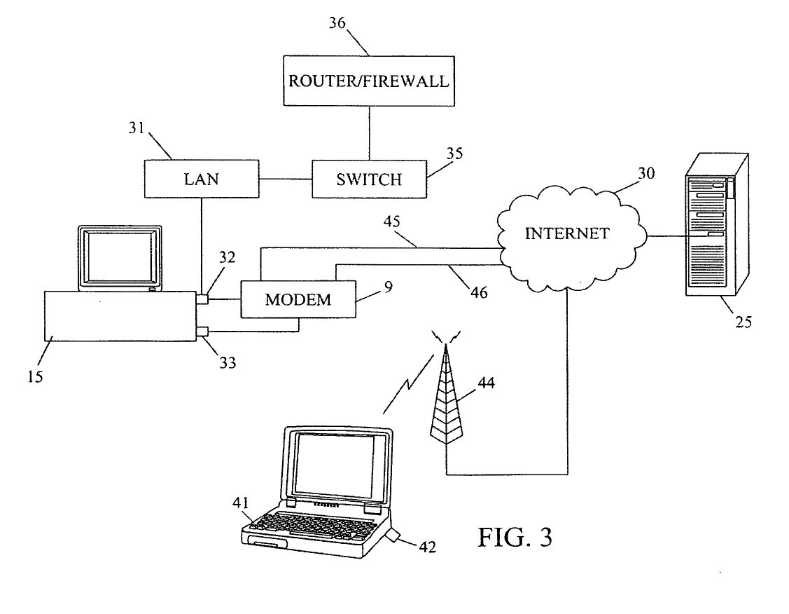

FIG. 3 illustrates a scenario when a remote installation is required, according to one embodiment of the invention. Following corruption of the hard disk or of the operating system of a target computer, i.e., the computer on which an operating system is to be installed, at step 51 the Live OS performs a bootstrapping operation from the RM 5 onto the RAM 7. At the next step 54 the Live OS performs hardware failure testing, so as to determine which services can be provided and/or to bypass failures, if possible. At the next step 57, the connectivity to the Internet is tested and if exists, at the next step 59 a secured channel to a predefined server (in this example, the safe-side server 25) is established. At the next step 61, the hardware signature of the computer system 15 is sent to the safe-side server 25. At the next step 62, the hardware options are received and then at step 63, the user selects from the proposed options. At step 64, the safe-side server 25 prepares installation package for that hardware. At the next step 66 the PVM 28 is loaded onto the RAM 7 and is bootstrapped from the prepared software package on the safe side server 25. At step 67, the OS installation runs inside the PVM 28 and installs on the HD 12. If the installation process was successful, at the next step 68 the computer system 15 is rebooted from the newly installed OS on the HD 12.

FIG. 3 illustrates several possibilities of network topologies, by which an operating system may be installed on a target computer by means of safe-side server 25 and the system of the present invention. Several connectivity options may be present within computer system 15. Such connectivity options may be:

1. Computer system 15 has a Network Interface Card (NIC) 32 that connects to a local network and receives network connectivity, such as a DHCP service.

2. Computer system 15 has a network interface card (NIC) 32 that connects to a modem, either a cable modem, a Digital Subscriber Line (DSL) modem 9 or any other.

3. Computer system 15 has a USB connection to modem 9.

4. Computer system 15 has a wireless interface networking card.

In option 1, networking is present. In options 2 and 3 networking/Internet connectivity is not present, so computer system 15 initializes and dials via modem 9 to one of a list of predefined internet accounts, until establishing connectivity with safe side server 25. In option 4, a wireless networking is attempted and if credentials are required, then the end user is prompted for these credentials.

Modem 9 can be connected to the ISP (Internet Service Provider) via either copper twisted pair 45 as a DSL modem or by means of a coaxial line 46 as a cable modem.

The wireless connection can be of type BT (Blue Tooth), WiFi (wireless fidelity), WiMAX or any other data connection.

In any of the network topologies, switch(es) 35 and router(s)/firewall(s) 36 may be used. When a wireless network is used, a base station 44 converts the wireless communication to a wired connection.

In another embodiment of the invention, the aforementioned method may be implemented to store data from the hard disk of the computer system to data files of the safe-side server 25. If the storage of the computer system becomes corrupted, the stored data files may be retrieved via the VPN channel.

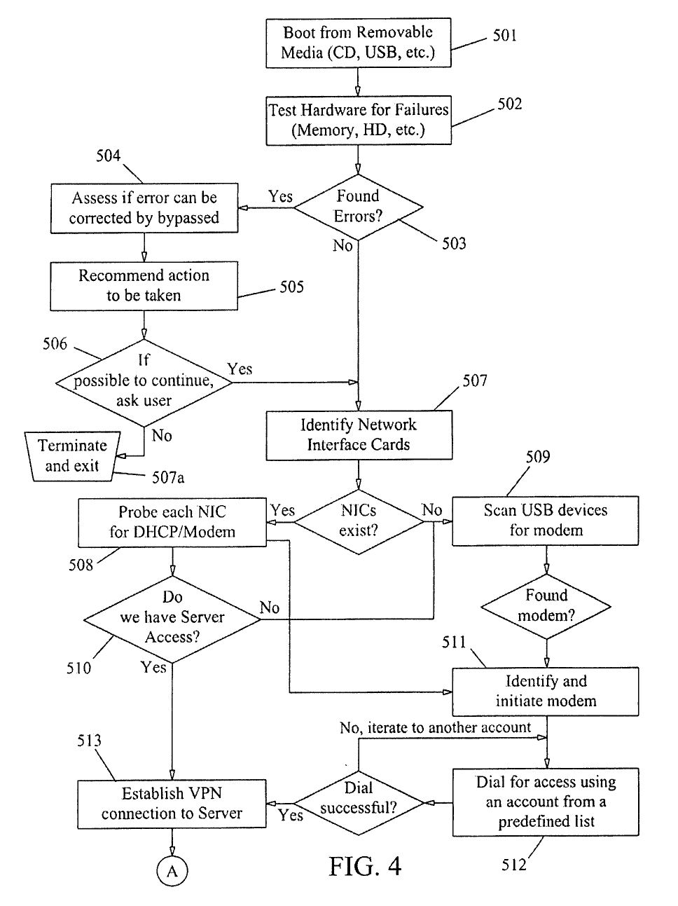

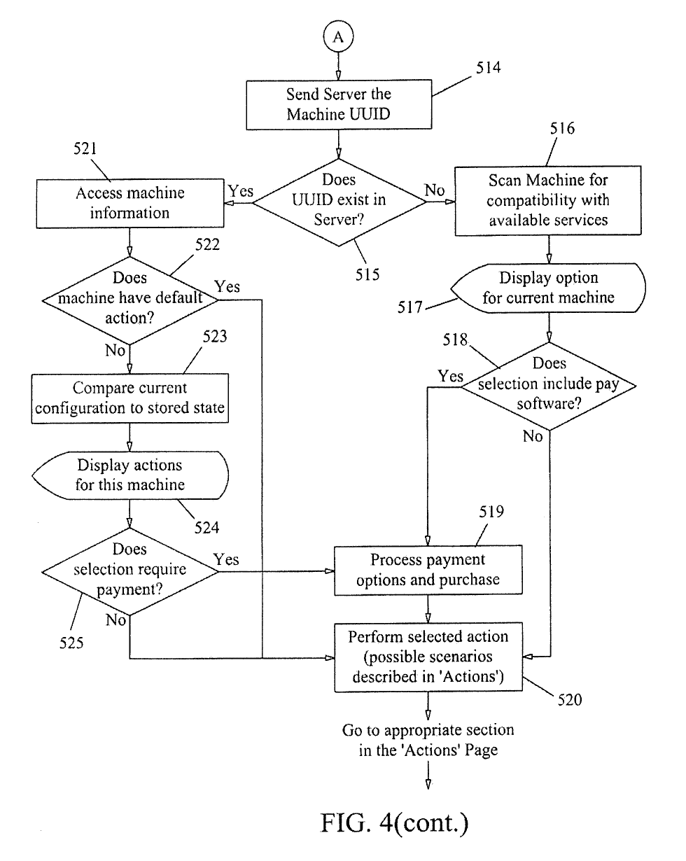

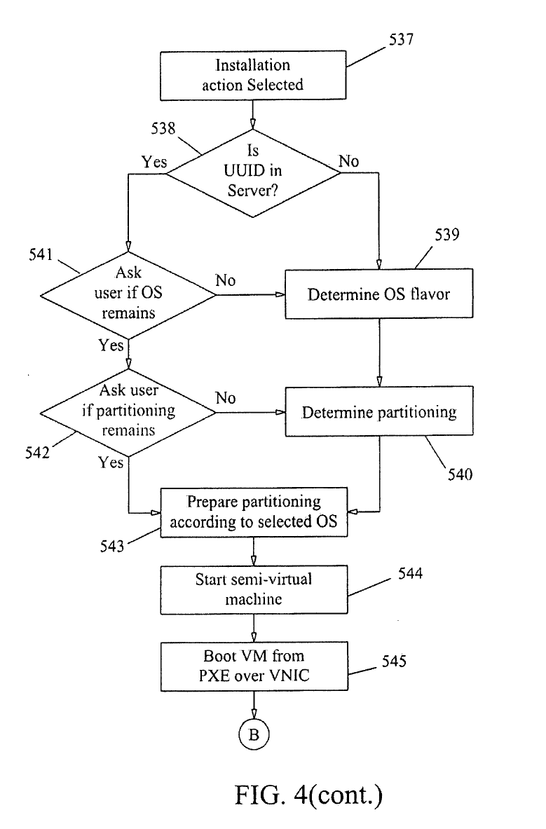

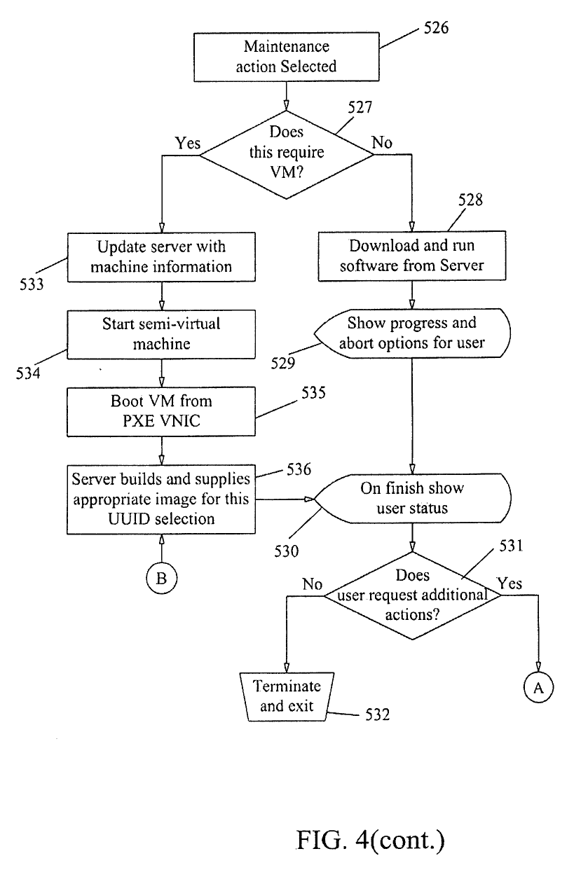

FIG. 4 is a flowchart of a preferred embodiment of the present invention. At the first step 501, the user inserts the removable boot media that contains the Live OS and program files and boots the machine from said media. At the next step 502, the essential hardware components (e.g., RAM, CPU and HD) are tested by the Live OS. At the next step 503, the Live OS checks if an error is found (for example, bad sectors in the HD). If found, at the next step 504, an assessment is made whether or not this error can be corrected or bypassed. For example, bad sectors in the HD can be marked and skipped, as well as addresses of bad modules of the RAM. At the next step 505, the user is prompted with proposed solutions (for example, if a module of the RAM is found problematic, the user may be asked to replace it). At the next step 506, if the error can be bypassed, the user is asked to confirm proceeding to the next step. Otherwise, the process is terminated at step 507a, while recommending what step should be taken. If confirmed, or no errors were found with the hardware, at the next step 507, the network connectivity is probed and identified and if exists, at step 508 the NIC's response to Dynamic Host Configuration Protocol (DFHCP—is a communications protocol that lets network administrators to centrally manage and automate the assignment of Internet Protocol (IP) addresses in a data network) is checked. At this point, it is possible to check whether or not the data network is connected to the Internet, so as to obtain access to the safe-side server, at step 510. Alternatively, probing for a modem can be performed. If found, at step 511 the modem is initiated and made ready for dial-up. If no network interface was found or connectivity could not be established, at step 509 the USB devices of the machine are scanned and probed, in order to find modems. At step 512, the modem dials to obtain access, using an account that is selected from a pre-stored list in the removable boot media. Once access to the safe-side server is obtained, at step 513, a secured connection such as a VPN channel (peer-to-peer) is established between the live OS and the safe-side server 25. At step 514, a “hardware signature” of the user's computer (which may be a number used to uniquely identify a hardware device) is sent over the secured channel to the safe-side server 25. At the next step 515, the system checks if the hardware signature already exists in the safe-side server 25, so as to determine if the user is subscribed or is a new user.

If the hardware signature does not exist (i.e., the user is not already subscribed), at the next step 516 the user's computer is scanned for determining compatibility with available services and is registered in the safe side server 25. At the next step 517, several available options for a new computer are offered to that user, for example, to scan his computer for viruses/malware, selling and installing (or reinstalling) of legal software (new OS, new applications, etc.). At the next step 518, the system checks if the user's selection requires payment. At the next step 519 purchasing and payment are performed.

If the hardware signature already exists (i.e., the user is subscribed), at step 521 the information about the user's computer is retrieved. At the next step 522, the system checks for predefined default actions to be taken in predetermined events (for example, full installation in case that the HD has been replaced); if such a predefined default action exists, step 520 automatically follows. At the next step 523, the Live OS scans the current configuration of the user's machine and sends it for comparison with the stored configuration, so as to determine whether an improved services package may be offered to that user. At the next step 524, the available options for that computer are presented to that user, for example, to scan his computer for viruses/malware, reinstallation, data restoration, defragmentation, etc.). At the next step 525, the system checks if the user's selection requires payment. At step 519 purchasing and payment are performed. At the next step 520 the selected action begins to be performed.

If a maintenance option is selected at the next step 526, the system checks at the next step 527 if the maintenance action requires using a PVM. If not, at the next step 528 the proper software is optionally downloaded and run from the safe-side server 25, while using the most updated version (e.g., for malware scanning such scanning may be performed using the live OS to achieve better performance by performing “external” scan, which is more reliable). At the next step 529 the system shows the user a progress indication and at the next step 530 the system shows the results and current status. At the next step 531 the system checks if the user requested additional actions. If not, the maintenance process is terminated at step 532. If he did request additional actions (for example, in case when not all the viruses have been detected and removed, the user may prefer to format the HD and reinstall), the system goes back to step 515.

If the maintenance action requires using a PVM, at the next step 533 the Live OS updates the safe-side server with the information that corresponds to the user's computer. For example, hardware components that might require additional or specialized drivers (e.g., NICs, video cards, chipsets, printers, etc.). At the next step 534 the system starts running the PVM and then at step 535 the PVM boots from the safe side server 25 over a virtual NIC (e.g., PXE boot), a virtual bootable device or over other form. At the next step 536 the appropriate image that was built by the safe-side server 25 for that specific user's computer is provided for the PVM boot operation and the process is redirected to step 530.

If an installation option is selected, at step 537 the system checks at the next step 538 if the hardware signature exists in the safe-side server 25. If not (i.e., the user is not subscribed or his default definitions have been changed), at the next steps 539 and 540, the user selects a desired OS and desired HD partitioning scheme, respectively. If the hardware signature exists in the safeside server 25 (i.e., the user is subscribed and his default definitions have not been changed), at steps 541 and 542, the user is asked if he wishes to keep the default OS and HD partitioning, respectively. At the next step 543 the HD is partitioned according to the selected OS. At the next step 544 the PVM is created, while at least the CPU, RAM and NIC are virtualized. At the next step 545, the PVM boots from the safe side server 25 over the virtual NIC, or virtual bootable device or other. At the next step 546 the process is redirected to step 536.

While some embodiments of the invention have been described by way of illustration, it will be apparent that the invention can be carried out with many modifications, variations and adaptations, and with the use of numerous equivalents or alternative solutions that are within the scope of persons skilled in the art, without departing from the spirit of the invention or exceeding the scope of the claims.

1. A disaster recovery system for the remote installation recovery, and restoration of software and/or data over a data network(s), comprising:
a) a computer system having at least one central processing unit (CPU), read/write internal memory means, an optional display, an optional input device, means for communicating with a data network, a bootable device input port and a hard disk;
b) bootable removable media means with a live operating system (OS) being stored therein; and
c) a server adapted to communicate with a plurality of computer systems, said server comprising:
d) a CPU and memory and software components for exchanging encrypted data with said computer system, installation packages, software packages, optional subscriber database with licensing information of each subscriber, and optional data files,
wherein said removable media means is operative in a first boot operation to scan hardware of said computer system and network connections, to establish networking connections, to establish a secured channel between said communicating means of said computer system and said server, over said networking connection and to transmit the optionally unique hardware signature of said computer system, over said secured channel to said server, for checking if the configuration that corresponds to said hardware signature exists, and for executing a default process or otherwise, proposing relevant recovery options to the user of said computer system and for preparing appropriate files and software packages for the selected recovery option.

2. The system according to claim 1, in which if required, the live OS downloads the required software components from the server.

3. The system according to claim 1, in which the live OS executes the required software components locally, after downloading, or from a removable media.

4. The system according to claim 1, in which the secured channel is a VPN, secured HTTP or an SSH or other type of a secure communication channel.

5. The system according to claim 1, in which the bootable removable media means is an optical drive or a Floppy drive or a USB port or any other type of a bootable media.

6. The system according to claim 1, in which if a partial VM is needed, the following steps are performed:
the Live OS locally executes the partial VM;
the VM performs boot operation over the secured channel, wherein the files required for that boot are read from the server;
the server prepares the files for the VM according to a default state, or to a selection of the user;
the VM then runs the required files.

7. The system according to claim 1, wherein the removable media means comprises a portable disk and associated drive in data communication with the internal memory means of the computer system.

8. The system according to claim 1, wherein the display and input device of the computer system are adapted to communicate user selected installation preferences in real-time.

9. The system according to claim 1, wherein the software package is an image extracted from the original operating system of the computer system, said image being representative of an essentially identical setup and configuration as that of the original operating system.

10. Method for disaster recovery, remote installation, and restoration of software and/or data over a data network, comprising:
a) Providing a computer system having at least one central processing unit (CPU), read/write internal memory means, an optional display, an optional input device, means for communicating with a data network, a bootable device input port and a hard disk;
b) coupling a bootable removable media means with a live operating system (OS) being stored therein to said computer system;
c) providing a server, adapted to communicate with a plurality of computer systems, said server comprising a CPU and memory and software components for exchanging encrypted data, software packages, optional subscriber database with licensing information of each subscriber, and optional data files, with said computer system;
d) allowing said removable memory means to perform a first boot operation, to scan hardware of said computer system and network connections, to establish networking connections, to establish a secured channel between said communicating means of said computer system and said server, over said networking connection and to transmit an optionally unique hardware signature over said secured channel to said server, for checking if the configuration that corresponds to the signature exists, and for executing a default process or otherwise, proposing relevant recovery options to the user of said computer system and for preparing appropriate files and software packages for the selected recovery option.

11. The method according to claim 10, in which if required, the live OS downloads the required software components from the server.

12. The method according to claim 10, in which the live OS executes the required software components locally, after downloading, or from a removable media.

13. The method according to claim 10, in which the secured channel is a VPN or an SSH or a secured HTTP session, such as HTTPS.

14. The method according to claim 10, in which if partial VM is needed, the following steps are performed:
the live OS locally executes the partial VM, which is virtualized at least over the CPU and memory and optionally over the network interface card of the computer system and/or any other bootable media;
the VM performs boot operation over the secured channel, wherein the files required for that boot are read from the server;
the server prepares the files for the VM according to a default state, or to the selection of the user;
the VM runs the required operation.

15. The method according to claim 10, wherein the bootable removable media means is an optical drive or a Floppy drive or a USB port or any other type of a bootable media.

16. The method according to claim 10, wherein the removable media means comprises a portable disk and associated drive in data communication with the internal memory means of the computer system.

17. The method according to claim 10, wherein the display and input device of the computer system are adapted to communicate user selected installation preferences in real-time.

18. The method according to claim 10, wherein the software package is an image extracted from the original operating system of the computer system, said image being representative of an essentially identical setup and configuration as that of the original operating system.

19. The method according to claim 10, wherein recovery operations comprise:
installing a new OS and software packages;
reinstalling OS and software packages;
recovery of deleted files and folders;
scanning and fixing parts of a corrupted OS and software;
extracting or replacing forgotten passwords;
scanning and removing malware; and
performing defragmentation and optimization of existing file system.

20. The method according to claim 10, wherein files and software packages are prepared for recovery by the server, according to the following steps:
combining generic OS installation files with matching and appropriate keys, serials and/or licenses;
generating and combining additional software packages with their matching and appropriate keys, serials and/or licenses;
generating one or more files containing information for unattended automatic uninterrupted installation;
optionally, generating and combining user data, settings and preferences stored in a storage system;
combining the generated installation files and additional files into a file system, for allowing a single continuous operation.
